(19) United States
(12) Patent Application Publication
(10) Pub. No.: US 2002/0123947 A1
(43) Pub. Date: Sep. 5, 2002

(54) Method and system for analyzing financial market data

(76) Inventors: Rafael Yuste, New York, NY (US); Vikram S. Kumar, Boston, MA (US); Robert C. Froemke, Oakland, CA (US); Paul Czkwianianc, New York, NY (US)

Correspondence Address: BAKER & BOTTS, 30 ROCKEFELLER PLAZA, NEW YORK, NY, 10112

(21) Appl. No.: 10/002,788

(22) Filed: Nov. 2, 2001

Related U.S. Application Data
(60) Provisional application No. 60/245,132, filed on Nov. 2, 2000.

(51) Int. Cl. G06F 17/60

(52) U.S. Cl. 705/35

(57) ABSTRACT

Disclosed is a method for analyzing a financial instrument data array. Events of interest in the financial instrument data array are detected and the events stored in an event array. The data is then analyzed to determine relationships between the detected events of interest and the statistical significance of those relationships.

### RELATED APPLICATION

This application claims priority from U.S. provisional application No. 60/245,132 filed on Nov. 2, 2000, which is incorporated by reference herein in its entirety.

### BACKGROUND OF INVENTION

The present invention relates to analyzing and interpreting datasets of financial market information. Examples of such datasets include closing price information for multiple financial instruments over time. As used herein, financial instrument means any commodity, security, instrument or contract traded on an open or closed market or exchange including stocks, bonds, options, future contracts, promissory notes and currencies.

It is often desirable to understand the relationship of various events occurring within a financial market information dataset. For example, share prices for various stocks may rise or fall with certain cohesiveness. It is desirable to determine which, if any, group of stocks ever exhibited correlated behavior (i.e. share prices rise or fall at the same time at least once in the period of observation), regularly exhibited correlated behavior (i.e. share prices rise or fall together on multiple occasions over the period of observation), and which stock, if any, consistently rises or falls before or after another stock rises or falls. It would also be advantageous to know the statistical significance of the relationships between the various events. In other words, whether the correlation among the various events is stronger than would be expected from random activity.

### SUMMARY OF THE INVENTION

These and other advantages are achieved by the present invention which in one respect provides a method for analyzing a financial market dataset and for detecting relationships between various events reflected in the dataset.

In an exemplary embodiment, a method is presented for analyzing a financial market data array with a first dimension and a second dimension. The array is examined to detect events of interest, and those events of interest are stored in an event array having the same dimensions as the financial market data array, but the data in each element of the event array is binary. The financial market data array or the event array is then analyzed to determine relationships between the events of interest and correspondingly, relationships between the financial instruments corresponding to the financial market data.

In an additional exemplary embodiment, analyzing includes plotting a portion or all of the data in the first simplified array to allow visual examination of the relationships between the activities of interest. In another exemplary embodiment, the analysis step involves detecting events of interest that are coactive and determining whether the number of coactive events is statistically significant. This embodiment may include detecting all such coactive events (i.e. instances where events where events occur in at least two financial instruments simultaneously), detecting instances where many financial instruments are coactive simultaneously, or detecting instances where two or more financial instruments are each active in a certain temporal relationship with respect to one another (also referred to as coactivity).

In a further exemplary embodiment, the data analysis involves calculating a correlation coefficient between two financial instruments based on how often the financial instruments are coactive relative to how often the first financial instrument is active. Representations of all such financial instruments are displayed with lines between representations of the financial instrument having a thickness proportional to the correlation coefficient between the two financial instruments.

Another exemplary embodiment includes plotting a cross-correlogram or histogram of events of interest in a particular financial instrument with respect to events of interest in another financial instrument, so that the histogram will reveal the number of times an event of interest in the first financial instrument occurs a certain number of locations away from an event of interest in the second financial instrument. The cross-correlogram can be plotted with respect to only one financial instrument, thus showing how many times an event of interest occurs before or after the occurrence of another event of interest in the same financial instrument.

Yet another exemplary embodiment includes displaying a time series “movie” showing activity occurring in one or more financial instrument relative to activity in a selected financial instrument. This “movie” is referred to herein as a spike triggered average. In this embodiment, a number of frames before and after events occurring in the selected financial instrument is chosen. A movie having the number of frames chosen is then displayed, with icons displayed for each non-selected financial instrument that was active within the chosen number of frames before or after activity occurring in the selected financial instrument. A parameter of the icon for each non-selected financial instrument, such as the color of the icon, is varied in each frame of the movie to correspond to the frequency that non-selected financial instrument is active and the corresponding number of frames before or after events occurring in the selected financial instrument.

Other exemplary embodiments include performing Hidden Markov Modeling on the event array to determine a hidden Markov state sequence and displaying a cross-correlogram between events of interest occurring in one region of interest while that region is in one of the detected Markov states and performing a singular value decomposition on the financial market data array.

In another aspect of the present invention there is provided a system for carrying out the foregoing method.

### BRIEF DISCRIPTION OF THE DRAWINGS

For a more complete understanding of the present invention, reference is made to the following detailed description of exemplary embodiments with reference to the accompanying drawings in which:

FIG. 1 illustrates a flow diagram of a method in accordance with the present invention;

FIG. 2 illustrates a visual plot generated in accordance with the method of FIG. 1;

FIG. 3 illustrates an example of a data structure useful in the method of FIG. 1;

FIG. 4 illustrates a flow diagram of a method of analyzing data useful in the method of FIG. 1;

FIG. 5 illustrates a visual plot generated in accordance with the method of FIG. 1;

FIG. 6 illustrates a cross-correlogram generated in accordance with the method of FIG. 1;

FIG. 7 illustrates a correlation map generated in accordance with the method of FIG. 1;

FIG. 8 illustrates an exemplary format for displaying analysis results useful with the method of FIG. 1;

FIG. 9 illustrates another exemplary format for displaying analysis results useful with the method of FIG. 1;

FIG. 10 illustrates yet another exemplary format for displaying analysis results useful in the present invention; and

FIG. 11 illustrates yet another exemplary format for displaying analysis results useful in the present invention.

### DESCRIPTION OF THE PREFERRED EMBODIMENT

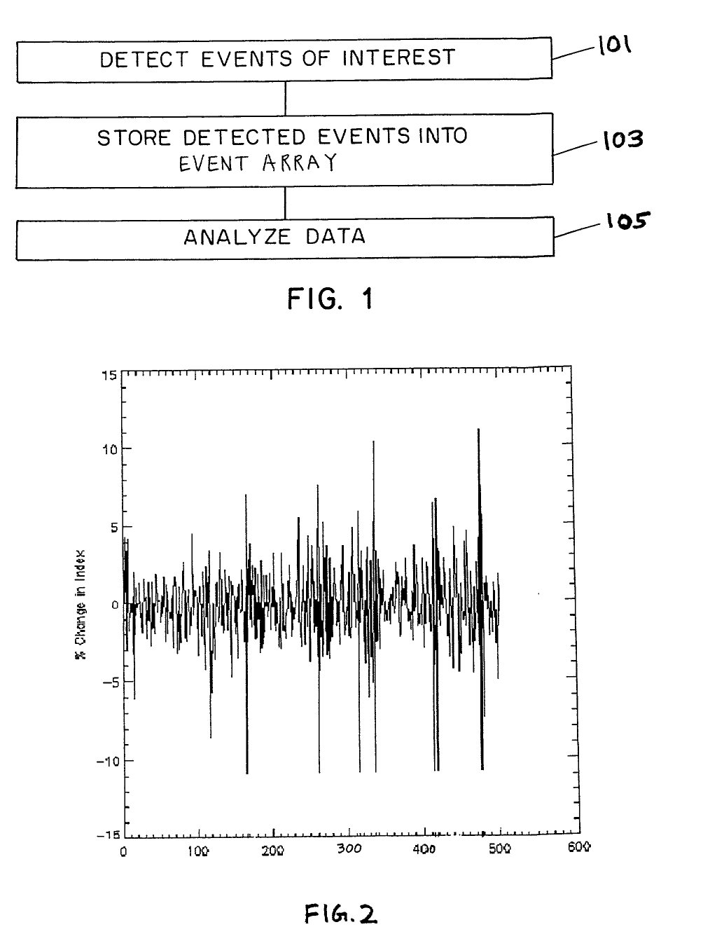

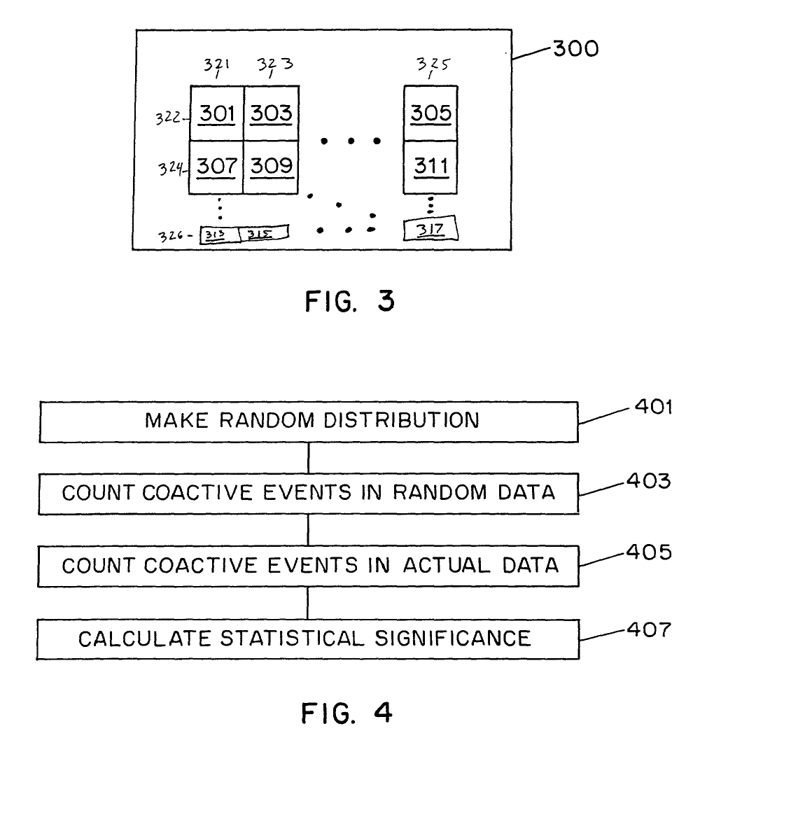

Referring to FIG. 1, there is shown a flow diagram representing an exemplary method for analyzing data pertaining to financial instruments in accordance with the present invention. For purposes of this description, the financial instrument data is arranged in an input array corresponding to a time series of daily closing prices for various publicly traded stocks. Thus, the data array is a two dimensional array, with one dimension (indexed by a first dimensional index) corresponding to the different stocks and the other dimension (indexed by a second dimensional index) corresponding to the dates the closing prices were observed. The format of this input data array will be discussed further herein with reference to FIG. 3. It will be understood that the present invention is not limited to the particular data described. For example, the input data could correspond to any parameter of any type of financial instrument sampled at any frequency. For example, rather than including closing price data, the input data array could consist of price/earning ratios, market capitalization or trading volume of the various stocks over time. Alternatively, the data could consist of closing quoted prices for a commodity, such a electricity, available for delivery at a certain geographic location. Moreover, rather than consisting of daily closing prices, the data could consist of prices observed at the expiration of any other temporal period, such as every five minutes, or every month. Numerous other potential input data sets will be apparent to one of ordinary skill in the art.

In the exemplary embodiment, performance of the method is assisted by a general purpose computer with a processor adapted to operate the MAC-OS operating system and to interpret program code written in Interactive Data Language (“IDL”) version 5.1 or later, developed by Research Systems, Inc. The IDL program code of the exemplary embodiment is appended hereto as Appendices A, B and C described further herein. Other operating systems and programming languages could be used to perform the steps of the exemplary embodiment without departing from the scope of the invention, and the modifications necessary to make such a change will be apparent to one of ordinary skill in the art.

In step 101, events of interest in the input financial data array are detected. To further understand this step in the exemplary embodiment, reference is made to FIG. 3 where an example of an input data array 300 is shown. Data array 300 is a two dimensional array input data having multiple rows 322, 324 . . . 326 and multiple columns 321, 323 . . . 325. Each one of the rows 322, 324 . . . 326 corresponds to a particular financial instrument, such as a particular stock. Thus, all data within a single row consists of observations corresponding to the same stock. Although only three rows are shown in FIG. 3, it will be understood that any number of rows could be present, the number of rows corresponding to the number of stocks under analysis. Each one of the columns 321, 323 . . . 325 corresponds to a particular time period, such as a particular day on which the observation was made. Thus, all data within a single column consists of observations occurring during the same day. Although only three columns are shown in FIG. 3, it will be understood that any number of columns could be present, the number of columns corresponding to the number of observations made. Each data element, 301, 303, 305, 307, 309, 311, 313, 315, 317 corresponds to a particular observation. For example, data element 309 corresponds to the observation of the stock corresponding to row 324 made during the period corresponding to column 323. Thus, data element 309 may contain the closing price of stock A observed on day X . In that scenario, data element 307 (which is in the same row as element 309) would contain the closing price of stock A observed during the period corresponding to column 321 and data element 315 (which is in the same column as element 309) would contain the closing price of the stock corresponding to row 326 observed on day X.

To assist in comparing the observations of different financial instruments trading at different prices, the data in input matrix 300 may be modified to contain percent change observations rather than actual closing price observations. For example, the closing price information for the stock associated with each row 322, 324 . . . 326 of input data could be modified to contain percent change rather than absolute closing prices as follows. Beginning with the data element in the second column 323, the difference in closing price from the observation in first column 321 to the observation in second column 323 is calculated. The resulting difference is then divided by the closing price observation in the first column 321. The resulting value is stored in the data element in the second column 323. The process is repeated until the final column 325 is reached. Each element in the first column of data (i.e. data elements 301, 307 . . . 313) is then set to zero. In this fashion, each data element will represent the percent change in closing price from the previous observation, rather than containing raw closing price data.

Returning now to FIG. 1, in step 101 the events of interest in the input data array 300 are detected. In one exemplary embodiment an event of interest is detected by calculating a statistical mean and standard deviation for all data elements corresponding to a particular stock. Thus, where the input data is contained in the array 300, a mean and standard deviation is calculated for all data in each row of the simplified array. An event is then detected where the data element value exceeds the mean for all data in the row by a predetermined number of standard deviations. If activity were defined by a drop in value rather than an increase in value, the event could be detected by examining the data values in a financial instrument for an entry where the data element value is less than the mean for all data in the row by a predetermined number of standard deviations. The number of standard deviations may be entered by a user before the calculations are preformed, or a default number may be used, such as two or three. In this fashion, the method will detect those instances in time where the closing price is much higher than the average closing price, thus suggesting an event of interest has occurred.

In another exemplary embodiment, an event is detected by looking for a data value that exceeds a previous data values corresponding to the same stock instrument by a threshold amount. Thus, for example, if the closing price stored in data element 309 exceeded the closing price stored in data element 307 by a certain percentage, an event is said to have occurred at the time corresponding to data element 307. Again, if an event were indicated by a drop in value rather than an increase, the detection step would involve looking for a stock price that is less than previous stock price of the same stock by the threshold amount. The threshold amount can be specified by a user before the calculations are performed, or a default number can be used, such as five percent. The detection can occur over many time periods, for example, the closing price of a particular stock on day six could be compared to the stock's closing price on day one to see if an increase beyond the threshold amount has occurred over that period. This would be useful to detect events that occur gradually over time rather than relatively instantaneously.

In step 103, the results of detection step 101 are stored in an event array. For this purpose, the event array is identical to the input array illustrated in FIG. 3; however, the data stored in the event array is binary rather than closing price values or percent changes. Thus, the entries in the event array would be 1 or 0 (or yes or no), corresponding to whether an event of interest occurred in the corresponding stock at the corresponding time.

In step 105, the stored data is analyzed. In one exemplary embodiment, the data is analyzed to determine whether various stocks are correlated (i.e. whether they are coactive), the strength of those correlations (i.e. how often they are coactive relative to how many times each stock or one of the stocks is active), how significant the correlations are (i.e. whether the correlation is stronger than would be expected if from a random data set) and the behavior of the entire observed stock population.

In the exemplary embodiment, the data is analyzed by plotting at least a portion of the data contained in the input data array 300. For example, stock price for one stock can be plotted over time. Stock prices for all observed stocks could also be plotted over time, either in separate plot windows or superimposed on the same plot window in either two or three dimensions. Additionally, the closing prices for all stocks could be averaged and plotted over time to show global behavior of the observed stocks. FIG. 2 illustrates one possible plot of stock closing price over time, expressed as percent change as previously described.

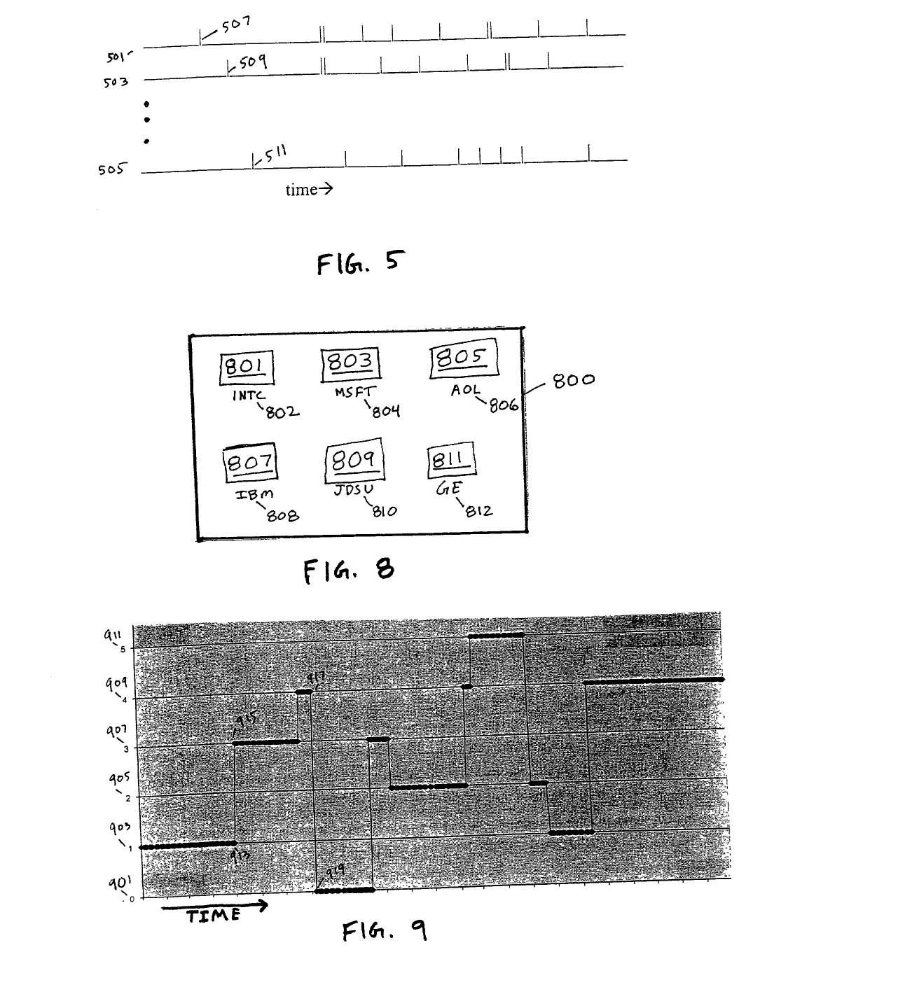

In another exemplary embodiment illustrated in FIG. 5, the data is analyzed by plotting at least a portion of the data contained in the event array. As shown, a plot of events over time may be presented for one or multiple stocks in the input data set. For example, events occurring in three stocks are shown plotted versus time in FIG. 5. Events for each stock are plotted on separate horizontal axes 501, 503 . . . 505. The vertical lines 507, 509, 511 represent events occurring at respective times in the corresponding stock.

In yet another exemplary embodiment illustrated in FIG. 4, the data in the financial data array is analyzed to determine the number of coactive events in the dataset and the statistical significance of those events. In step 401, a random distribution of stock price activity is generated. The random data is generated by shifting the data in each row of the input data array by a random amount. In step 403, the number of coactive events in the random dataset is counted. This process is repeated numerous times to generate a random distribution. The number of random trials may be set by the user or a default number of random trials may be conducted, such as 1000.

Counting coactive events for this purpose means counting all instances where two stocks are coactive. Coactive events for this purpose means events of interest that occurred in two stocks at the same time, or within a specified number of time intervals from each other. Thus, if the specified number of time intervals is one, then if a event occurred in the stock corresponding to row 322 at the time corresponding to column 321 (i.e. data element 301) and an event occurred in the stock corresponding to row 324 at the time corresponding to column 323 (i.e. data element 309), those events would be considered coactive. The time interval may be specified by a user before coactive events are counted, or may be a default setting such as two time intervals.

Once the random trials have been completed and a random distribution of coactive events generated, the actual number of coactive events in the data is calculated in step 405 using the same counting methodology was used to count coactive events in the random trials. The actual number of coactive events is then superimposed on a plot of the random distribution. The statistical significance of the coactive events is determined in step 407 by calculating the area under the distribution curve to the right of the number of actual coactive events in the data. This result, termed the “p-value” represents the probability that the number of detected coactive events in the actual data is produced by a random activity.

In a further exemplary embodiment, a random distribution of activity is generated as previously described, except the only coactive events that are counted in steps 403 and 405 are those where a predetermined number of stocks are coactive. The predetermined amount of coactive stocks may be specified by a user or a predetermined default value such as four may be used. Additionally, it may be specified whether exactly that many coactive events must be present or at least that many coactive events must be present to be considered a coactive event for counting. Thus, the embodiment allows instances of multiple simultaneously active stocks (rather than simply two simultaneously active stocks) to be counted and the statistical significance of that number to be reported. In this exemplary embodiment, the random distribution and actual number of coactive events are plotted. The statistical significance of the actual number of coactive events is calculated using the formula: C_{rand}/N_{rand} where C_{rand} is the number of random trials that resulted in more coactive matches than the actual data set and N_{rand} is the total number of random trials used to generate the random distribution, and is reported to a user. Additionally, a chart may be drawn showing all observed stocks with line segments connecting those stocks that were coactive, such as the chart described herein with reference to FIG. 7.

In a still further exemplary embodiment, a random distribution of stock activity is generated as previously described except the only coactive events that are counted in steps 403 and 405 are those where at least two stocks are active a predetermined number times throughout the dataset. The number of times the two or more stocks must be active can be specified by a user or a default number such as two may be used. In this exemplary embodiment, the random distribution and actual number of coactive events are plotted. The statistical significance of the actual number of coactive events is calculated using the formula: C_{rand}/N_{rand} where C_{rand} is the number of random trials that resulted in more coactive matches than the actual data set and N_{rand} is the total number of random trials used to generate the random distribution, and is reported to a user. Additionally, a chart may be displayed showing all observed stocks with line segments connecting those stocks that were coactive, such as the chart described herein with reference to FIG. 7.

In yet another exemplary embodiment, a correlation map is plotted. To plot the correlation map, a correlation coefficient array is first generated for all of the stocks. The correlation coefficients are defined as C(A,B)=number of times stock A and B are coactive divided by the number of times stock A is active. For this purpose, coactive means active at the same time, or within a specified number of time intervals of each other. The number of time intervals may be specified by a user or a default number such as one time increment may be used. The number of correlation coefficients will be equal to the square of the number of stocks observed. A correlation map is then drawn consisting of a map of all stocks with lines between each pair of stocks having a line thickness proportional to the correlation coefficient of those two stocks. An example of such a correlation map is illustrated in FIG. 7. There, an icon representing each observed stock 701, 703, 705, 707, 709, 711 is plotted around a circle 713. The thickness of line 717 is proportional to the magnitude of the correlation coefficient for stocks 701 and 709. Line 715, which appears thicker than line 717, indicates that the correlation between stocks 705 and 709 is stronger than the correlation between stocks 701 and 709. Similarly, line 719, which appears thicker than lines 715 or 717, indicates that the correlation between stocks 701 and 705 is stronger than the correlation between stocks 701 and 709 or stocks 705 and 709. If the correlation coefficient is below a predetermined threshold amount, the corresponding line may be omitted from the correlation map. The predetermined threshold amount may be specified by a user or a default threshold may be used.

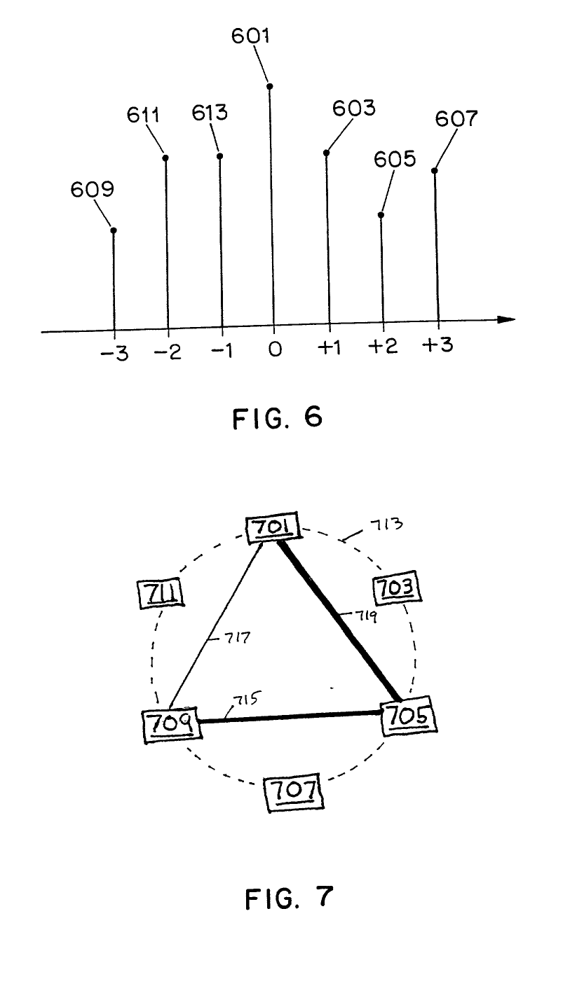

In still another exemplary embodiment, a cross correlogram is drawn to show potential causality among stock activity. This can be used to find stocks with events that consistently precede or follow events of another stock. A cross correlogram simply creates a histogram of the time intervals between events in two specified stocks. A line of height proportional to the number of times the second stock is active one time interval following activity by the first stock is plotted at +1 on the x-axis of the histogram. A line of height proportional to the number of times the second stock is active two time intervals following activity by the first stock is plotted at +2 on the x-axis of the histogram, and so on. An example of such a cross correlogram is illustrated in FIG. 6. The line 601 represents the number of occasions the first and second stocks were active at the same time, while line 607 represents the number of times the second stock was active three time intervals after the first stock was active. A cross correlogram may be plotted for a single stock to detect temporal characteristics in the stock's activity such as the fact that the stock is active with a period of every three time intervals a certain number of times during the period of observation.

IDL code implementing all of the preceding steps of the exemplary embodiment is attached hereto as Appendix A. The procedure “MultiStock” and “MultiStock_event” are the main procedures. All relevant sub-procedures and functions are also included in Appendix A.

An exemplary embodiment related to the cross-correlogram provides for displaying what is referred to as a “spike triggered average”, which consists of a time series “movie” showing activity occurring in one or more stocks under investigation relative to activity in a selected stock. In this embodiment, a particular reference stock is selected. A data window consisting of a number of frames before and after events occurring in the selected stock (known as primary events) is then chosen or a default number of frames may be used, such as ten. In the event ten frames are chosen, the resulting movie will consist of twenty-one frames, ten frames corresponding to the ten time periods before each event occurring in the reference stock, one frame corresponding to the time of each event in the reference stock and ten frames corresponding to the ten time periods after each event in the reference stock.

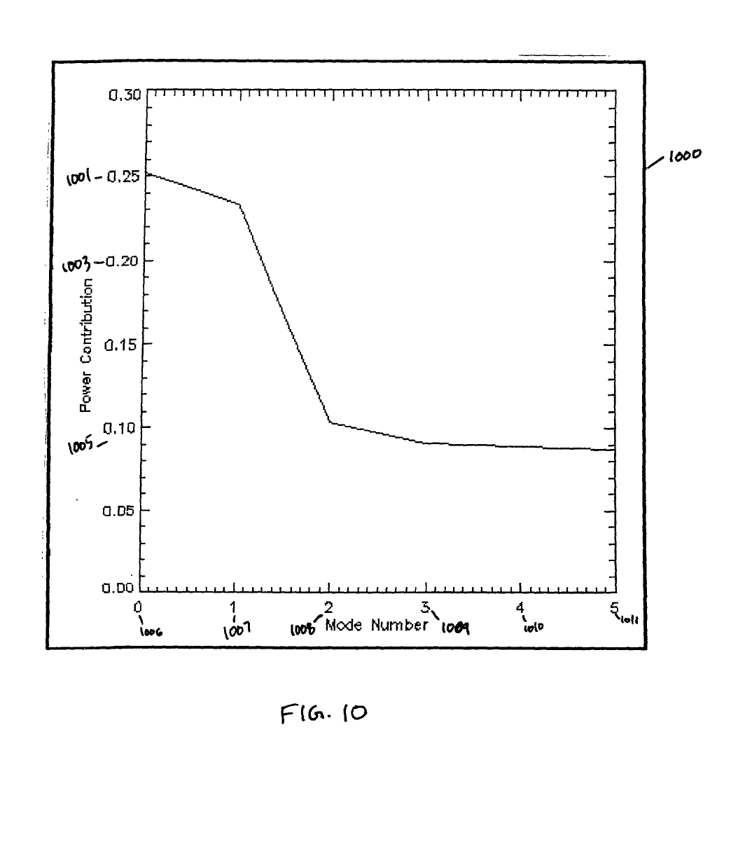

Each frame of the movie will consist of a representation of all stocks under investigation. An example of such a frame is shown in FIG. 8. There, frame 800 consists of several icons 801, 803, 805, 807, 809 and 811, each corresponding to a stock under investigation. Each icon may be a solid square. The representations may also include ticker symbols 802, 804, 806, 808, 810 and 812 to further identify the stocks under investigation. A parameter of the icon for each stock, such as the color of the icon, is varied in each frame of the movie. The parameter varies in each frame to correspond to the frequency that events occur in the stock under investigation (known as secondary events) at the corresponding number of time periods before or after an event occurs in the reference stock.

For example, if the reference stock selected had respective events at times t=20 and t=50 and a movie length of twenty-one frames was selected, corresponding to ten frames before and ten frames after each primary event (i.e. an event in the reference stock), the movie would appear as follows. The first frame would be derived based on events occurring in the stocks under investigation at time t=10 and t=40 (i.e. 10 time periods before the respective events in the reference stock). Thus, if the first stock under investigation had an event at time t=10 and t=40, the icon parameter for that stock that is displayed in the first frame would correspond to an event always occurring ten frames before an event in the reference stock, for example the icon color may be red. If the stock under investigation instead had an event at time t=10, but not at time t=40, the icon parameter for that stock that is displayed in the first frame would correspond to an event occurring half the time ten frames before an event in the reference stock, for example the icon color may be orange. The process is repeated for each stock under investigation for each of the frames in the spike triggered average movie. The resultant movie will illustrate the frequency that events occur in the stocks under investigation at the corresponding number of time periods before or after events occurring in the reference stock. This information may be used to uncover possible causality in the temporal domain among the stocks by identifying stocks whose activity appears to trigger or be triggered by activity in other stocks.

In a still further exemplary embodiment, the data is analyzed in step 105 of FIG. 1 by finding a hidden Markov state sequence from the event array. This embodiment uses the principal of Hidden Markov modeling described in Rabiner, A Tutorial on Hidden Markov Models and Selected Applications in Speech Recognition, Proceedings of the IEEE, vol. 77 pp. 257-286 (1989), which is incorporated by reference herein. Essentially, a Markov model is a way of modeling a series of observations as functions of a series of Markov states. Each Markov state has an associated probability function which determines the likelihood of moving from that state directly to any other state. Moreover, there is an associated initial probability matrix which determines the likelihood the system will begin in any particular Markov state. In a hidden Markov Model, the Markov states are not directly observable. Instead, each state has an associated probability of producing a particular observable event. A complete Markov model requires the specification of the number of Markov states (N); the number of producible observations per state (M); the state transition probability matrix (A), where each element aᵢⱼ of A is the probability of moving directly from state i to state j; the observation probability distribution matrix (B), where each element bᵢ(k) of B is the probability of producing observation k while in state i; and the initial state distribution (P), where each element pᵢ of P is the probability of beginning the Markov sequence in state i.

In the exemplary embodiment, it is assumed that the number of times events occur in a stock within each Markov state follows the Poisson distribution. Thus, each stock in each state has an associated Poisson Lambda parameter, which can be understood in the exemplary embodiment to correspond to the rate at which events occur in the stock. The set of all of these Lambda parameters is then assumed to be the B matrix. Given the estimations of the Markov Model parameters, the method uses the Viterbi algorithm to find the single best state sequence, i.e. the sequence of Markov states that most likely occurred to generate the observed results. The number of Markov states N may be selected by the user, or a default number such as six states may be used. The Viterbi algorithm is described as follows:

Initialization:

δ₁(i)=pᵢbᵢ(O₁)1≦i≦N, (1)

ψ₁(i)=0, (2)

Recursion:

$$\begin{matrix}\begin{matrix}{δ}_{t} ( j ) = {max}_{1 \leq i \leq N} [ {δ}_{t - 1} ( i ) {a}_{ij} ] {b}_{i} ( {O}_{t} ) & 2 \leq i \leq T \\ & 1 \leq j \leq N ,\end{matrix} \\ & ( 3 ) \\ \begin{matrix}{ψ}_{t} ( j ) = {arg max [ {δ}_{t - 1} ( i ) {a}_{ij} ]}_{1 \leq i \leq N} & 2 \leq t \leq T \\ & 1 \leq j \leq N ,\end{matrix} & ( 4 )\end{matrix}$$

Termination:

$$\begin{matrix}{p}^{*} = {max}_{1 \leq i \leq N} [ {δ}_{T} ( i ) ] , \\ & ( 5 ) \\ {q}_{T}^{*} = {arg max}_{1 \leq i \leq N} [ {δ}_{T} ( i ) ] , & ( 6 )\end{matrix}$$

Path (backtracking):

qₜ*=ψₜ₊₁(qₜ₊₁*)t=T−1,T−2, . . . ,1. (7)

In the algorithm, δₜ(i) represents the highest probability along a single path through all possible Markov state sequences up to time t that accounts for the first t observations (Oₜ) and ends in state i. ψ is used to store the argument which maximizes δₜ(i). Once a possible state sequence qₜ* is generated, the state sequence plot can be generated such as the one shown in FIG. 9. In that example, six states are shown, corresponding to horizontal lines 901, 903, 905, 907, 909, 911. Each point on the plot represents the Markov state the model is in at the relevant time. For example, point 913 represents the Markov model being in state 903 while point 915 represents the model being in state 907. Each different state represents differing behavior of the stocks. For example, one group of stocks may exhibit events of interest more frequently than the remaining stocks when the model is in the first state 901, while those same stocks may exhibit fewer or no events when the model is in the second state 903. Correspondingly, another group of stocks may exhibit more frequent events of interest while in the third state 905 than other stocks and fewer events of interest while in the fourth state 907.

A cross-correlogram between stocks in a selected state can be plotted using the methodology previously described, where only event data corresponding to the time the model is in the selected state is used in generating the cross-correlogram. The state may be selected by the user or a default state such as the first state may be used.

IDL code implementing the preceding embodiment involving the hidden Markov model is attached hereto as Appendix B. The procedure “hiddenmarkov” and “hidden_markov_event” are the main procedures. All relevant sub-procedures and functions are also included in Appendix B.

In a yet further exemplary embodiment the data is analyzed by performing a singular valued decomposition (SVD) on the data in the input stock data array, such as that shown in FIG. 3. In this embodiment, it is not necessary to detect events or store events in an event array. A singular valued decomposition takes advantage of the fact that in some sets of data produced from N different sources, such as N different stocks, some of the stocks will not be creating independent data. In other words, there may be degeneracy in the data, which allows the data set to be decomposed into a number of eigenmodes i.e., orthogonal eigenvectors, with the eigenvalue (or singular value) representing the weight of the eigenvector in the system.

In a singular valued decomposition, the data set is reduced from N dimensions, where N is the number of selected stocks, to d dimensions, where d is the specified number of eigenmodes and is less than N. The SVD algorithm, which is well known to one of ordinary skill in the art and is specified in the code in Appendix C, fits the observed stock data to a data model that is a linear combination of d number of functions of the spaces of data (such as time and stock price). Since d is specified rather than calculated by looking for degeneracy in the data, the resultant decomposition constitutes an approximation. Minimizing the sum of the squares of the errors in the approximation to the model, the SVD algorithm discards the eigenmodes corresponding to the smallest N−d eigenvalues.

The stock data may be preprocessed before the SVD is performed by subtracting the median from each stock's closing price data. In other words, for each stock, a median is calculated and subtracted from each closing price entry for that stock. Additionally, when a positivity constraint is employed in the SVD algorithm (i.e. when only stock prices rising above the baseline are considered) an absolute value of the resultant data may be taken to ensure that downward events (i.e. drops in stock prices below the baseline) are considered in performing the SVD.

In this embodiment, the result that is plotted for visual analysis may be the level of each stock's contribution to each of the calculated d eigenmodes. For example, the result may be displayed in the format shown in FIG. 8, with each stock represented by an icon 801, 803, 805, 807, 809 and 811 and optionally a ticker symbol 802, 804, 806, 808, 810 and 812. A parameter of the icon, such as its color, may be adjusted to represent the level of the stock's contribution to the displayed eigenmode. A separate plot can be generated for each of the calculated d eigenmodes.

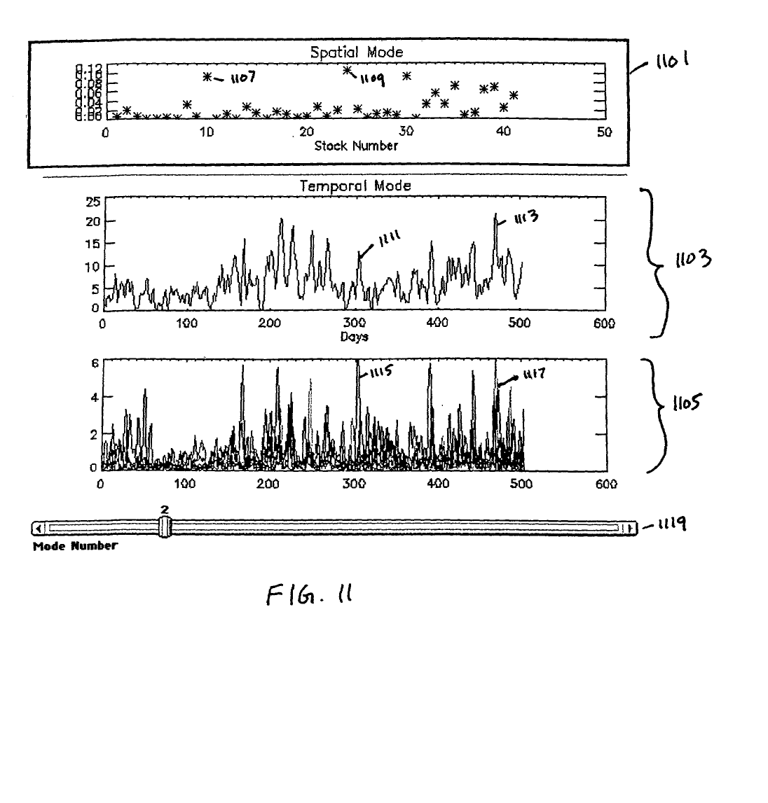

Alternatively, a plot, such as that shown in FIG. 10 may be generated to display the results of the SVD. This plot 1000, which displays singular values on the y-axis and mode number on the x-axis, represents the power of each mode in explaining the variance of the data set (i.e. the strength with which each of the calculated modes explains the tendency of the stock prices to deviate from the baseline). The example plot 1000 shows that most of the variance is explained by mode 0 (1006), mode 1 (1007) and mode 2 (1008), while modes 3 (1009), 4 (1010) and 5 (1011) explain little of the activity in the data set.

A third visualization useful to show the result of the SVD is shown in FIG. 11. In that example, three windows 1101, 1003 and 1005 are shown. The user first selects the mode for which data should be displayed, such as by using the slider bar 1119. In the top window 1101, an icon for each stock (e.g. 1107, 1009) in the data set is displayed, with the stock's position on the y-axis corresponding to the strength with which that stock participates in the selected mode. The middle window 1103 shows a time series representation of the selected mode. In other words, window 1103 displays the aggregate stock activity corresponding to the selected mode. The bottom window 1105 is a superimposed plot of all of the stocks participating in the selected mode. As can be seen, the spike occurring around time day 300 (1115) in the bottom plot 1105 corresponds to the spike occurring at the same time (1111) in the aggregate mode activity shown in the middle plot 1103. Similarly, the spike occurring around day 480 (1117) in the bottom plot 1105 corresponds to the spike occurring at the same time (1113) in the middle plot 1103. Thus, it can be seen that activity in the identified stocks shown in the bottom plot 1105 does constitute the activity of the mode shown in the middle plot 1103.

IDL code implementing the preceding embodiment involving the singular value decomposition algorithm is attached hereto as Appendix C. The procedure “ssvd_gui” and “ssvd_gui_event” are the main procedures. All relevant sub-procedures and functions are also included in Appendix C.

Although the present invention has been described in detail with reference to exemplary embodiments thereof, it should be understood that various changes, substitutions and alterations can be made hereto without departing from the scope or spirit of the invention as defined by the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A method for analyzing data pertaining to a plurality of financial instruments traded on a financial market, comprising the steps of:
(a) arranging the financial instrument data in an array of data elements wherein each data element of the array has a respective first dimensional index and a respective second dimensional index;
(b) detecting events of interest in said financial instrument data in the array;
(c) storing said detected events of interest as entries in an event array in binary format, the event array having the same dimensions as said financial instrument data array; and
(d) analyzing data in one array selected from the group consisting of said financial instrument data array and said event array to determine correlations between said detected events of interest.

2. The method of claim 1, wherein said financial instrument data array comprises an array of closing prices for said plurality of financial instruments over a plurality of time periods.

3. The method of claim 2, wherein said first dimensional index corresponds to said plurality of financial instruments and said second dimensional index corresponds to said plurality of time periods.

4. The method of claim 3, wherein said step of detecting events of interest comprises:
calculating a statistical mean and statistical standard deviation from a data population consisting of all of the data elements in said financial instrument data array having identical first dimensional indexes, for each of said first dimensional indexes; and
determining for each data element in said financial instrument data array whether said data element exceeds, by a predetermined number of said standard deviations, the mean of the data population and denominating such a data element an event.

5. The method of claim 4, wherein each one of the entries in said event array corresponds to a respective one of the data elements of the financial instrument data array and has the same first and second dimensional indexes as the corresponding data element in said financial instrument data array and wherein said storing said detected events of interests comprises storing a logical “one” at a location in said event array having the first and second dimensional indexes of the corresponding data element when the corresponding data element is denominated an event and storing a logical “zero” at the location in said event array having the first and second dimensional indexes of the corresponding data element when the corresponding data element is not denominated an event.

6. The method of claim 3, wherein said detecting events of interest comprises determining whether a first data element in said financial instrument data array exceeds, by a threshold amount, a second data element in said financial instrument data array, wherein said second data element has an identical first dimensional index as said first data element and a second dimensional index corresponding to an earlier point in time than the second dimensional index of said first data element, and denominating said second data element an event.

7. The method of claim 6, wherein each one of the entries in said event array corresponds to a respective one of the data elements of the financial instrument data array and has the same first and second dimensional indexes as the corresponding data element in said financial instrument data array and wherein said storing said detected events of interests comprises storing a logical “one” at a location in said event array having the first and second dimensional indexes of the corresponding data element when the corresponding data element is denominated an event and storing a logical “zero” at the location in said event array having the first and second dimensional indexes of the corresponding data element when the corresponding data element is not denominated an event.

8. The method of claim 3, wherein said step of analyzing data comprises detecting said events of interest that are coactive and determining whether the number of coactive events is statistically significant.

9. The method of claim 8, wherein said step of detecting events of interest that are coactive comprises detecting instances where said events of interest are detected in at least a first and a second entry of said event array, wherein said second data entry has a first dimensional index distinct from the first dimensional index of said first entry and wherein said first and second entries each have second dimensional indexes corresponding to a simultaneous time period.

10. The method of claim 9, wherein said coactive events of interest occur at a plurality of time periods in a data population consisting of all data elements in said event array having a first dimensional index identical to the first dimensional index of said first entry or said second entry.

11. The method of claim 3, wherein said step of analyzing comprises calculating a strength of correlation between at least two of said financial instruments based on the number of coactive events of interest occurring in said at least two of the financial instruments and displaying a correlation map illustrating the strength of correlation between said financial instruments by lines connecting representations of the financial instruments wherein the thickness of each of the lines is proportional to said calculated strength of correlation between respective financial instruments having associated representations connected by the line.

12. The method of claim 3, wherein said step of analyzing data comprises displaying a cross-correlogram between events of interest occurring in at least one of said financial instruments.

13. The method of claim 3, wherein said step of analyzing data comprises detecting at least one hidden Markov state sequence from said event array.

14. The method of claim 13, wherein said step of analyzing data further comprises displaying a cross-correlogram between events of interest occurring in one of said financial instruments while said financial instrument is in one of said detected hidden Markov states.

15. The method of claim 1, wherein said step of analyzing data comprises plotting at least a portion of said data elements in said financial instrument data array for visual analysis.

16. The method of claim 1, wherein said analyzing step (d) comprises providing a dimension number representing the number of dimensions in which to model said financial instrument data and performing a singular valued decomposition on said selected array to decompose said financial instrument data array into a number of eigenmodes corresponding to said dimension number.

17. A method for analyzing data pertaining to a plurality of financial instruments traded on a financial market, comprising the steps of:
(a) arranging the financial instrument data in an array of data elements, wherein said financial instrument data array comprises data pertaining to the financial instruments over a plurality of time periods and wherein each data element of the array has a respective first dimensional index corresponding to a respective one of the financial instruments and a respective second dimensional index corresponding a respective one of said plurality of time periods;
(b) providing a dimension number representing the number of dimensions in which to model said financial instrument data;
(c) performing a singular valued decomposition on said financial instrument data array to decompose said financial instrument data array into a number of eigenmodes corresponding to said dimension number; and
(d) analyzing said decomposed data to determine relationships between at least two of said financial instruments.

18. The method of claim 17, wherein said analyzing comprises visually displaying for at least one of said eigenmodes a representation of each of said financial instruments participating in said displayed eigenmode.

19. The method of claim 18, wherein a parameter of each representation of a respective financial instrument indicates the amount of the respective financial instrument's participation in said displayed eigenmode.

20. A method for analyzing data pertaining to a plurality of financial instruments traded on a financial market comprising the steps of:
(a) arranging the financial instrument data in an array of data elements, wherein said financial instrument data array comprises data pertaining to the financial instruments over a plurality of time periods and wherein each data element of the array has a respective first dimensional index corresponding to a respective one of the financial instruments and a respective second dimensional index corresponding a respective one of said plurality of time periods;
(b) selecting a reference financial instrument;
(c) detecting any primary event of interest occurring in a data population consisting of all data elements in said financial instrument data array having a first dimensional index corresponding to the first dimensional index of said reference financial instrument;
(d) providing a data window corresponding to a number of said time periods before and after each of said detected primary event of interest within which to search for secondary events of interest;
(e) detecting any secondary event of interest occurring in a region of said financial instrument data array having a first dimensional index corresponding to the first dimensional index of at least one of said financial instruments not selected as said reference financial instrument and having a second dimensional index corresponding to a time period of observations occurring within said data window of said at least one primary event of interest detected during said detecting step (c); and
(f) displaying a sequence of visualizations, wherein the number of visualizations displayed has a time duration equal to said data window size, wherein each visualization corresponds to one of said time periods before or after an occurrence of said at least one detected primary event of interest, wherein each visualization comprises a representation of said at least one of said financial instruments for which secondary events of interest are detected in said detecting step (e) and a parameter of said representation of said financial instrument indicates the frequency with which said secondary events of interest occur in said financial instrument the corresponding number of time periods before or after said detected primary event of interest.

21. A system for analyzing data pertaining to a plurality of financial instruments traded on a financial market comprising:
a data storage for storing the financial instrument data in an array of data elements, each data element of the array having a respective first dimensional index and a respective second dimensional index;
an event detector for detecting events of interest in said financial instrument data array;
a data transformer for storing as entries said detected events of interest into an event array in binary format, the event array having the same dimensions as said financial instrument data array; and
a data analyzer for analyzing data in one array selected from the group consisting of said financial instrument data array and said event array, to determine correlations between said detected events of interest.

22. The system of claim 21, wherein said financial instrument data array comprises an array of closing prices for said plurality of financial instruments over a plurality of time periods.

23. The system of claim 22, wherein said first dimensional index corresponds to said plurality of financial instruments and said second dimensional index corresponds to said plurality of time periods.

24. The system of claim 23, wherein said event detector further comprises:
a statistical calculator for calculating a statistical mean and statistical standard deviation from a data population consisting of all of the data elements in said financial instrument data array having identical first dimensional indexes, for each of said first dimensional indexes; and
a comparator for determining for each data element in said financial instrument data array whether the data element exceeds, by a predetermined number of said standard deviations, the mean of the data population, denominating such a data element an event.

25. The system of claim 24, wherein each entry stored by said data transformer in said event array corresponds to a respective one of the data elements of the financial instrument data array and has the same first and second dimensional indexes as the corresponding data element in said financial instrument data array and wherein said data transformer stores a logical “one” at a location in said event array having the first and second dimensional indexes of the corresponding data element when the corresponding data element is denominated an event and stores a logical “zero” at a location in said event array having the first and second dimensional indexes of the corresponding data element when the corresponding data element is not denominated an event.

26. The system of claim 23, wherein said event detector determines whether a first data element in said financial instrument data array exceeds, by a threshold amount, a second data element in said financial instrument data array wherein said second data element has an identical first dimensional index as said first data element and a second dimensional index corresponding to an earlier point in time than the second dimensional index of said first data element and denominates said second data element an event.

27. The system of claim 26, wherein each entry stored by said data transformer in said event array corresponds to a respective one of the data elements of the financial instrument data array and has the same first and second dimensional indexes as the corresponding data element in said financial instrument data array and wherein said data transformer stores a logical “one” at a location in said event array having the first and second dimensional indexes of the corresponding data element when the corresponding data element is denominated an event and stores a logical “zero” at a location in said event array having the first and second dimensional indexes of the corresponding data element when the corresponding data element is not denominated an event.

28. The system of claim 23, wherein said data analyzer detects said events of interest that are coactive and determines whether the number of coactive events is statistically significant.

29. The system of claim 28, wherein said data analyzer detects said events of interest that are coactive by detecting instances where said events of interest are detected in at least a first and second entry of said event array, wherein said second data entry has a first dimensional index distinct from the first dimensional index of said first entry and wherein said first and second entries each have second dimensional indexes corresponding to a simultaneous time period.

30. The system of claim 29, wherein said data analyzer detects said events of interest that are coactive by detecting instances where said coactive events of interest occur at a plurality of time periods in a data population consisting of all data elements in said event array having a first dimensional index identical to the first dimensional index of said first entry or said second entry.

31. The method of claim 23, wherein said data analyzer calculates a strength of correlation between at least two of said financial instruments based on the number of coactive events of interest occurring in said at least two of the financial instruments and displays a correlation map illustrating the strength of correlation between said financial instruments by lines connecting representations of financial instruments wherein the thickness of each of the lines is proportional to said calculated strength of correlation between respective financial instruments having associated representations connected by the line.

32. The system of claim 23, wherein said data analyzer displays a cross-correlogram between events of interest occurring in at least one of said financial instruments.

33. The system of claim 23, wherein said data analyzer detects at least one hidden Markov state sequence from said event array.

34. The system of claim 33, wherein said data analyzer displays a cross-correlogram between events of interest occurring in one of said financial instruments while said financial instrument is in one of said detected hidden Markov states.

35. The system of claim 21, wherein said data analyzer plots at least a portion of said data elements in said financial instrument data array for visual analysis.

36. The system of claim 21, wherein said data analyzer further comprises a receiver for receiving a dimension number representing the number of dimensions in which to model said financial instrument data and a decomposes for performing a singular valued decomposition on said selected array to decompose said financial instrument data into a number of eigenrodes corresponding to said dimension number.

37. A system for analyzing a data pertaining to a plurality of financial instruments traded on a financial market comprising:
a data storage for storing the financial instrument data arranged in an array of data elements, wherein said financial instrument data array comprises data pertaining to the financial instruments over a plurality of time periods and wherein each data element of the array having a respective first dimensional index corresponding to a respective one of the financial instruments and a respective second dimensional index corresponding to a respective one of said plurality of time periods;
a receiver for receiving a dimension number representing the number of dimensions in which to model said financial instrument data;
a decomposer for performing a singular valued decomposition on said financial instrument data array to decompose said financial instrument data array into a number of eigenmodes corresponding to said dimension number; and
a data analyzer for analyzing said decomposed data to determine relationships between at least two of said financial instruments.

38. The system of claim 37, wherein said data analyzer visually displays for at least one of said eigenmodes a representation of each of said financial instruments participating in said displayed eigenmode.

39. The system of claim 38, wherein a parameter of each representation of a respective financial instrument indicates the amount of the respective financial instrument's participation in said displayed eigenmode.

40. A system for analyzing data pertaining to a plurality of financial instruments traded on a financial market comprising:
a data storage for storing the financial instrument data in an array of data elements, wherein said financial instrument data array comprises data pertaining to the financial instruments over a plurality of time periods and wherein each data element of the array has a respective first dimensional index corresponding to a respective one of the financial instruments and a respective second dimensional index corresponding to a respective one of said plurality of time periods;
a selector for selecting a reference financial instrument;
a primary detector for detecting any primary event of interest occurring in a data population consisting of all data elements in said financial instrument data array having a first dimensional index corresponding to the first dimensional index of said reference financial instrument;
a receiver for receiving a data window corresponding to a number of said time periods before and after each of said detected primary event of interest within which to search for secondary events of interest;
a secondary detector for detecting any secondary event of interest occurring in a region of said financial instrument data array having a first dimensional index corresponding to the first dimensional index of at least one of said financial instruments not selected as said reference financial instrument and having a second dimensional index corresponding to a time period of observations occurring within said data window of said at least one primary event of interest; and
a data analyzer for displaying a sequence of visualizations, wherein the number of visualizations displayed has a time duration equal to said data window size, wherein each visualization corresponds to one of said time periods before or after an occurrence of said at least one detected primary event of interest, wherein each visualization comprises a representation of said at least one of said financial instruments for which secondary events of interest are detected and a parameter of said representation of said financial instrument indicates the frequency with which said secondary events of interest occur in said financial instrument the corresponding number of time periods before or after said detected primary event of interest.
